(19) United States
(12) Patent Application Publication
(10) Pub. No.: US 2019/0394438 A1
(43) Pub. Date: Dec. 26, 2019

(54) IMAGE PROCESSING DEVICE, DIGITAL CAMERA, AND NON-TRANSITORY COMPUTER-READABLE STORAGE MEDIUM

(71) Applicant: Sharp Kabushiki Kaisha, Sakai City, Osaka (JP)

(72) Inventors: Aya OKAMOTO, Sakai City (JP); Naoko GOTO, Sakai City (JP)

(73) Assignee: Sharp Kabushiki Kaisha, Sakai City, Osaka (JP)

(21) Appl. No.: 16/465,264

(22) PCT Filed: Oct. 30, 2017
(86) PCT No.: PCT/JP2017/039189

§ 371 Date: May 30, 2019

(30) Foreign Application Priority Data
Dec. 1, 2016 (JP) 2016-234515

(51) Int. Cl. H04N 9/64; H04N 5/232; H04N 5/235

(52) U.S. Cl. CPC H04N 9/646; H04N 5/2352; H04N 9/643; H04N 5/23229

(57) ABSTRACT

An image processing device includes: an evaluation unit configured to evaluate an attribute of each one of pixel blocks in accordance with at least one piece of pixel information in that pixel block, the pixel blocks being specified by dividing an image into a plurality of regions; a process determining unit configured to determine, in accordance with a result of the evaluation performed by the evaluation unit, a process specific to be applied to the at least one piece of pixel information; and an image processing unit configured to process the at least one piece of pixel information.

### TECHNICAL FIELD

The following disclosure relates to an image processing device and a digital camera including the image processing device. The following disclosure relates also to an image processing program for running a computer as the image processing device and to a storage medium containing such an image processing program.

### BACKGROUND ART

Image data, or image-representing digital information (digital signals), may be automatically subjected to image processing to make the image look better. As an example, Patent Literature 1 discloses an image processing device that (1) divides, into blocks of pixels, monochromatic image data obtained from CCDs (charge coupled devices) through photoelectric conversion of an original document, (2) determines whether each of the divided blocks is a binary image region or a grayscale image region, (3) performs a binary process on the blocks that are determined to be binary image regions, and (4) performs a dithering process on the blocks that are determined to be grayscale image regions.

### CITATION LIST

### Patent Literature

Patent Literature 1: Japanese Unexamined Patent Application Publication, Tokukaisho, No. 64-61170 (Publication Date: Mar. 8, 1989)

### SUMMARY OF INVENTION

### Technical Problem

The image processing device described in Patent Literature 1, however, is capable of performing image processing only on image data representing a monochromatic image and is therefore not applicable to currently popular color image data.

The present invention, in an aspect thereof, has been made in view of this problem and has an object to provide an image processing device capable of performing image processing not only on image data representing a monochromatic image, but also on image data representing a color image, in such a manner as to make the image look better.

### Solution to Problem

To address the problem, the present invention, in one aspect thereof, is directed to an image processing device including: an evaluation unit configured to evaluate an attribute related to at least any one of luminance, hue, and saturation of each one of pixel blocks in accordance with at least one piece of pixel information in that pixel block, the pixel blocks being specified by dividing an image into a plurality of regions; a process determining unit configured to determine, in accordance with a result of the evaluation performed by the evaluation unit, a process specific to be applied to the at least one piece of pixel information; and an image processing unit configured to process the at least one piece of pixel information in accordance with the process specific.

### Advantageous Effects of Invention

The present invention, in an aspect thereof, provides an image processing device capable of performing image processing not only on image data representing a monochromatic image, but also on image data representing a color image, in such a manner as to make the image look better.

### BRIEF DESCRIPTION OF DRAWINGS

FIG. 1 is a block diagram of a digital camera including an image processing device in accordance with a first embodiment of the present invention.

FIG. 2 is a flow chart representing a flow of a process carried out in the image processing device shown in FIG. 1.

FIG. 3 is a plan view of an image divided into m rows and n columns by an image dividing unit provided in the image processing device shown in FIG. 1.

Portions (a) to (c) of FIG. 4 are example luminance histograms for pixel blocks into which an image is divided by the image dividing unit provided in the image processing device shown in FIG. 1.

Portions (a) and (b) of FIG. 5 are example graphs each representing a tone curve for selection by an image processing unit provided in the image processing device shown in FIG. 1.

FIG. 6 is an enlarged plan view of image blocks, showing example process specifics determined by a process determining unit provided in the image processing device shown in FIG. 1.

FIG. 7 is an enlarged plan view of image blocks, showing other example process specifics determined by the process determining unit provided in the image processing device shown in FIG. 1.

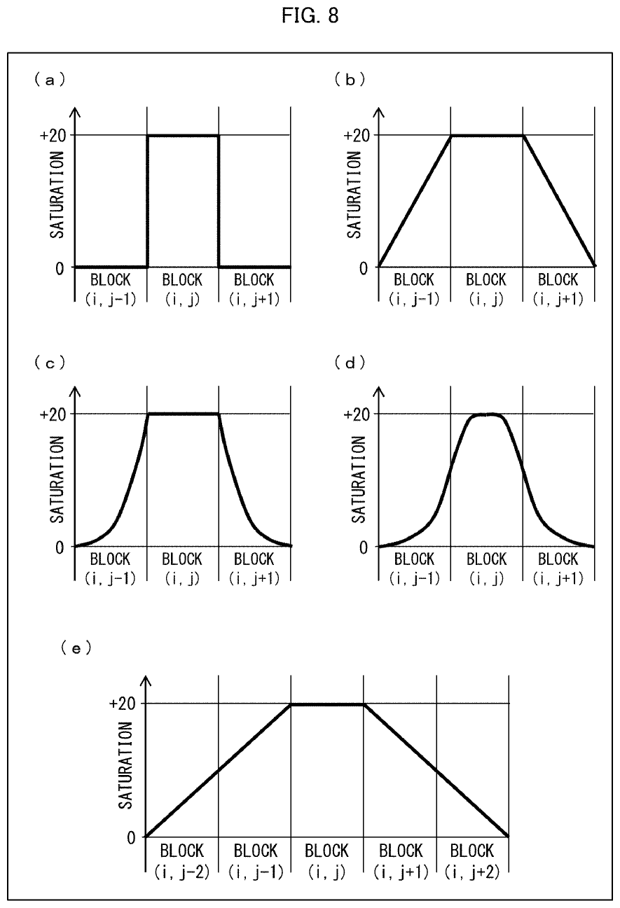

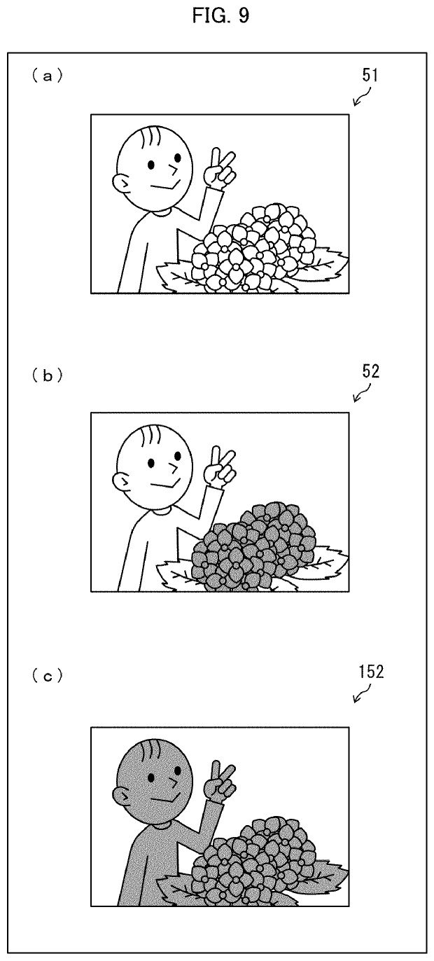

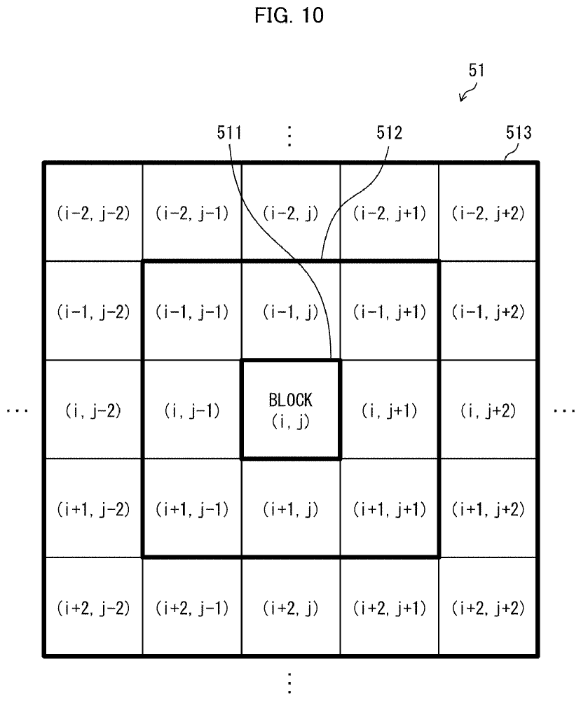

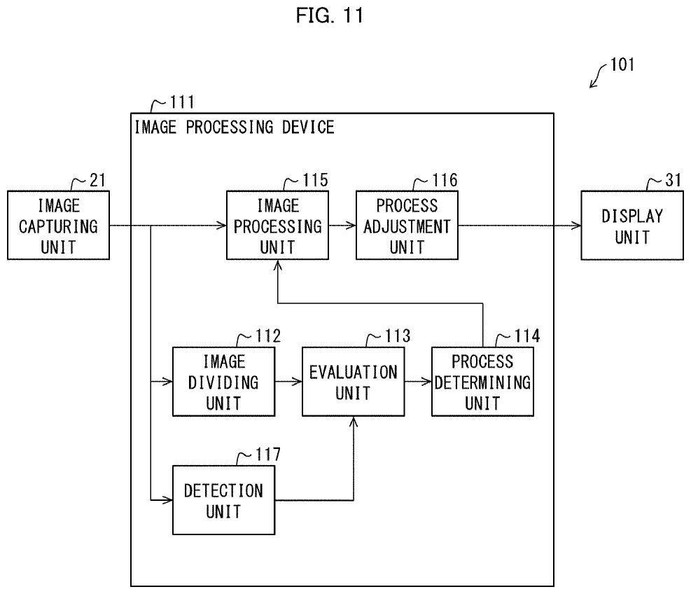

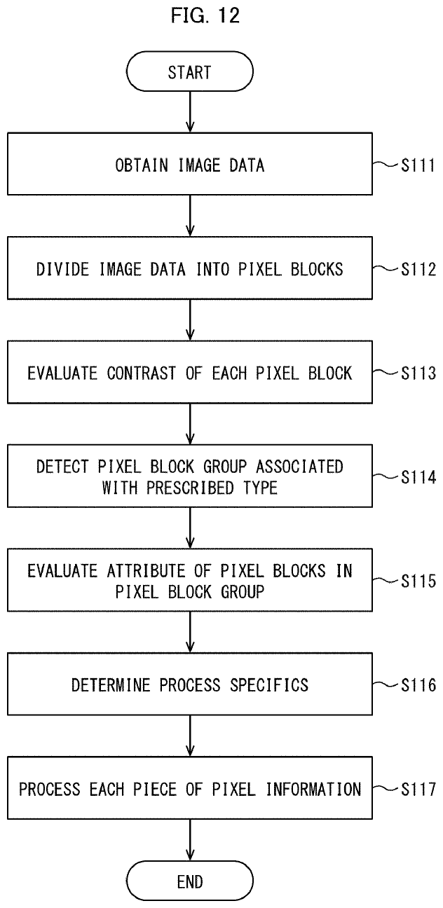

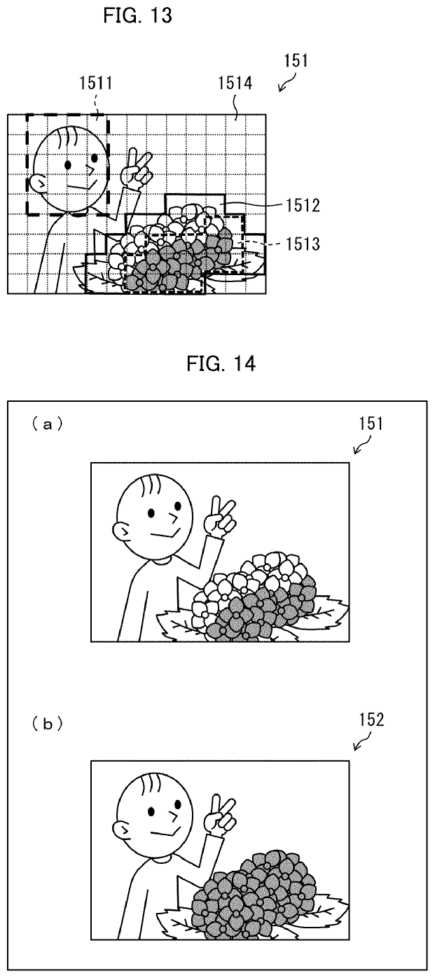

Portion (a) of FIG. 8 is a graph representing a saturation parameter level when the image blocks in row i in FIG. 7 are subjected to a process that merely increases saturation and involves no edge processing. Portions (b) to (e) of FIG. 8 are graphs representing a saturation parameter level when the image blocks in row i in FIG. 7 are subjected to a process that increases saturation and also involves edge processing.

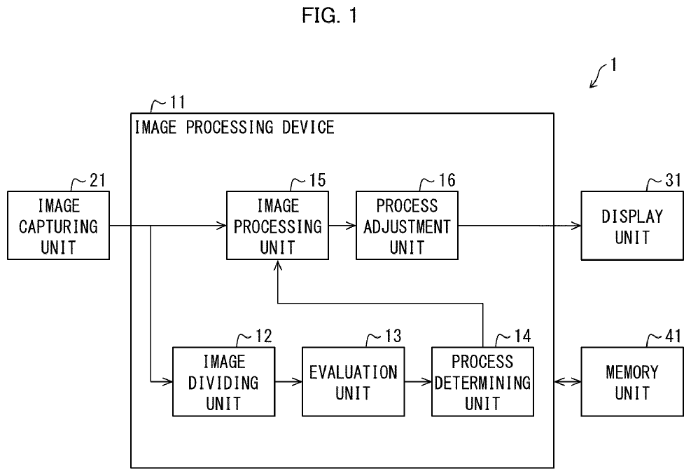

Portion (a) of FIG. 9 is an image represented by pixel information that is obtained by the image processing device shown in FIG. 1, (b) of FIG. 9 is an image represented by pixel information that has been subjected to image processing in the image processing device shown in FIG. 1, and (c) of FIG. 9 is an image represented by pixel information that has been subjected to image processing in an image processing device in accordance with a comparative example.

FIG. 10 is an enlarged plan view of an arrangement of pixel blocks (i,j) the attributes of which are evaluated by an evaluation unit provided in an image processing device in accordance with a second embodiment of the present invention.

FIG. 11 is a block diagram of a digital camera including an image processing device in accordance with a third embodiment of the present invention.

FIG. 12 is a flow chart representing a flow of a process carried out in the image processing device shown in FIG. 11.

FIG. 13 is a plan view of a screen displaying pixel block groups each associated with a prescribed type of subject by a detection unit provided in the image processing device shown in FIG. 11.

Portion (a) of FIG. 14 is an image represented by pixel information that is obtained by the image processing device shown in FIG. 11, and (b) of FIG. 14 is an image represented by pixel information that has been subjected to image processing in the image processing device shown in FIG. 11.

### DESCRIPTION OF EMBODIMENTS

### First Embodiment

The following will describe an image processing device 11 in accordance with a first embodiment of the present invention and a digital camera 1 including the image processing device 11, in reference to FIGS. 1 to 9.

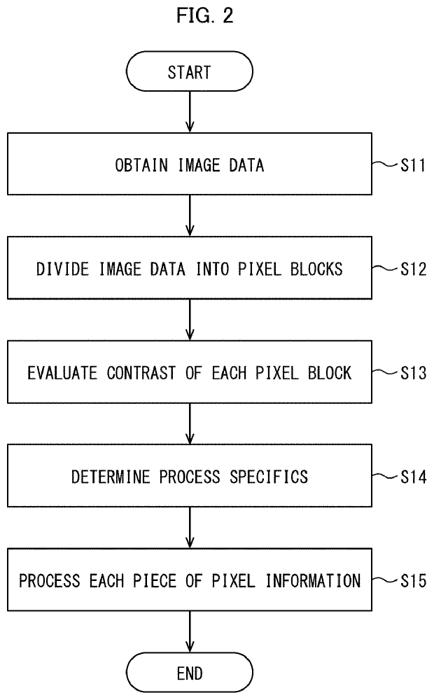

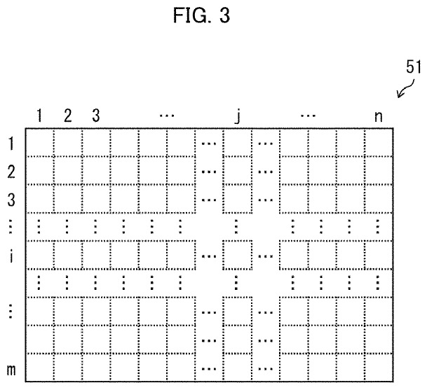

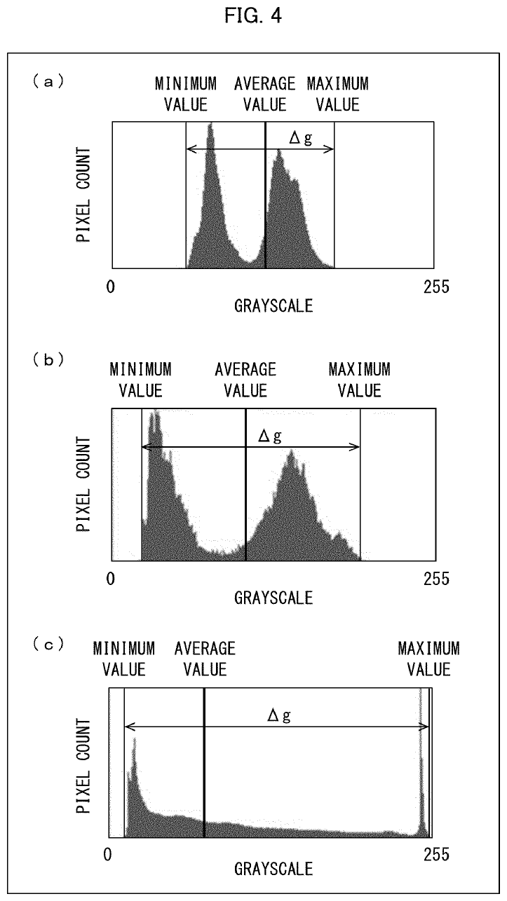

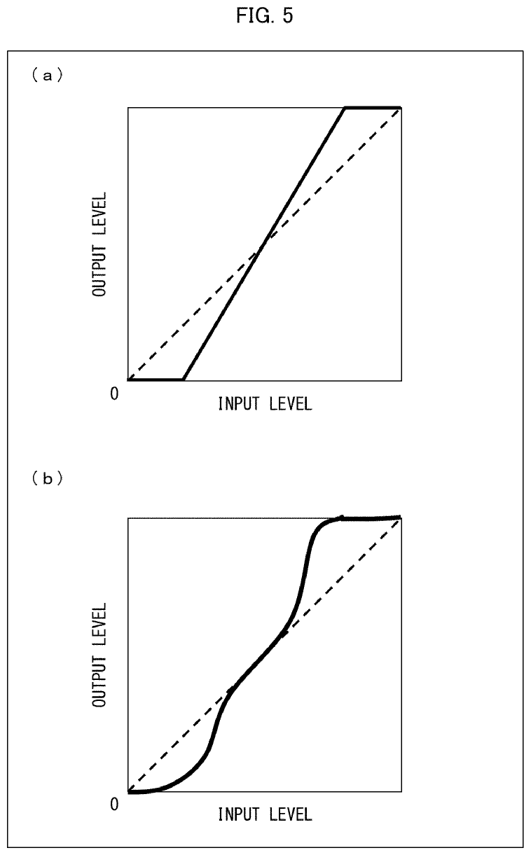

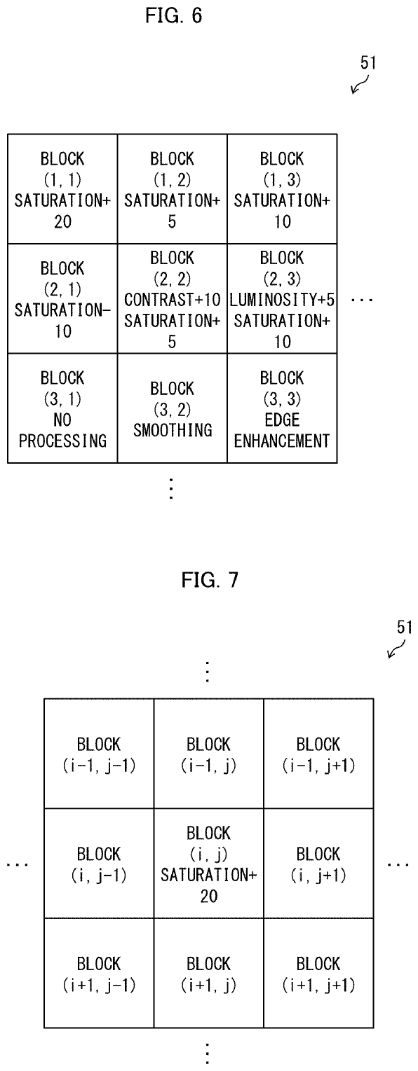

FIG. 1 is a block diagram of the digital camera 1. FIG. 2 is a flow chart representing a flow of a process carried out in the image processing device 11. FIG. 3 is a plan view of an image 51 divided into m rows and n columns by an image dividing unit 12 provided in the image processing device 11. Portions (a) to (c) of FIG. 4 are example luminance histograms for pixel blocks into which an image is divided by the image dividing unit 12 provided in the image processing device 11. Portions (a) and (b) of FIG. 5 are example graphs each representing a tone curve for selection by an image processing unit 15 provided in the image processing device 11. FIGS. 6 to 9 will be described later.

### Overview of Digital Camera 1

Referring to FIG. 1, the digital camera 1 includes the image processing device 11, an image capturing unit 21, a display unit 31, and a memory unit 41.

The image capturing unit 21 includes: a matrix of red, green, and blue color filters; an image sensor including a matrix of photoelectric conversion elements; and an analog/digital converter (A/D converter). The image capturing unit 21 converts the intensities of the red, green, and blue components of light transmitted simultaneously by the color filters to electric signals and further converts the electric signals from analog to digital for output. In other words, the image capturing unit 21 outputs color pixel information representing an image produced by the simultaneously incident red, green, and blue components of light.

The image capturing unit 21 is, for example, a CCD (charge coupled device) image sensor or a CMOS (complementary metal oxide semiconductor) image sensor.

The image processing device 11 obtains image data generated by the image capturing unit 21 and processes pixel information constituting the image data so as to make the image represented by the image data look better. The image processing device 11 outputs the image data constituted by the processed pixel information to the display unit 31 and the memory unit 41.

The display unit 31 displays an image represented by image data that is processed by the image processing device 11. The display unit 31 is, for example, an LCD (liquid crystal display).

The memory unit 41 is a recording medium that stores the image data constituted by the pixel information processed by the image processing device 11. The memory unit 41 includes a main memory unit and an auxiliary memory unit. The main memory unit includes a RAM (random access memory). The auxiliary memory unit may be, as an example, a hard disk drive (HDD) or a solid state drive (SSD).

The main memory unit is a memory unit where an image processing program contained in the auxiliary memory unit is loaded. The main memory unit may be used also to temporarily store the pixel information processed by the image processing device 11. The auxiliary memory unit stores the pixel information processed by the image processing device 11 in a non-volatile manner, as well as stores an image processing program as described above.

The image capturing unit 21, the display unit 31, and the memory unit 41 in the digital camera 1 may be provided by using existing technology. A description is now given of a configuration of the image processing device 11 and a process performed by the image processing device 11.

### Configuration of Image Processing Device 11

Referring to FIG. 1, the image processing device 11 includes the image dividing unit 12, an evaluation unit 13, a process determining unit 14, the image processing unit 15, and a process adjustment unit 16. The image processing unit 15 and the process adjustment unit 16 are, respectively, the image processing unit and the process adjustment unit recited in claims. Referring to FIG. 2, the image processing method performed by the image processing device 11 includes step S11, step S12, step S13, step S14, and step S15. In step S11, image data is obtained. The image data is then divided into a plurality of pixel blocks in step S12. The contrast of each pixel block is evaluated in step S13. Step S14 then determines the specifics of a process to be performed on each piece of pixel information in each pixel block. The process is performed on each piece of pixel information in each pixel block in step S15.

### Image Dividing Unit 12

The image dividing unit 12 obtains image data representing the color image 51 from the image capturing unit 21 and divides the image data representing the image 51 into m rows and n columns of pixel blocks (see FIG. 3). In other words, the image dividing unit 12 performs step S11 and step S12. Each pixel block includes a matrix (i.e., rows and columns) of pixels.

The image data is divided into m×n pixel blocks, where m and n are positive integers. The pixel block in position (i,j) may be referred to as a block (i,j) throughout the following description. Note that i may be any integer from 1 to m inclusive, and j may be any integer from 1 to n inclusive. The “block(s) (i,j)” is a generalized notation of divided pixel blocks.

The image data representing the color image 51 in the present embodiment represents a color for each pixel by using pixel information, that is, the optical intensities (gray levels) of the red, green, blue components. The pixel information processed by the image processing device 11 is not necessarily given in the form of R, G, and B signals that respectively represent gray levels for the three colors, red, green, and blue. For example, the pixel information processed by the image processing device 11 may be given in the form of R, G, B, and Ye signals that respectively represent gray levels for four (yellow as well as red, green, and blue) colors. As a further alternative, the pixel information may be given in the form of a Y signal that represents luminance and two signals (U and V signals) that represent a color difference.

Each block (i,j) preferably includes 50 to 300 pixels in each column and 50 to 300 pixels in each row, to efficiently improve the visual appearance of the image. The pixel count of the column in the block (i,j) is obtained by dividing the pixel count of the column in the image by m, or the number of blocks in each column in the image. Likewise, the pixel count of the row in the block (i,j) is obtained by dividing the pixel count of the row in the image by n, or the number of blocks in each row in the image. The block (i,j) may be arranged such that the pixel count of the column is equal to the pixel count of the row or such that the pixel count of the column differs from the pixel count of the row.

If the block (i,j) includes very few pixels, that is, if each column and row of the block (i,j) include fewer than 50 pixels, it may become difficult to determine what characteristics the block (i,j) has, which could lead to a failure in selecting optimal specifics for the process. On the other hand, if the block (i,j) includes too many pixels, that is, if each column and row of the block (i,j) include more than 300 pixels, the block (i,j) will more likely have a variety of characteristics, which could lead to a failure in selecting optimal specifics for the process.

Suitable specifics can be selected for a process to make the image look better, by dividing the image represented by the image data into a plurality of pixel blocks in such a manner that each column and row of the block (i,j) include from 50 to 300 pixels.

### Evaluation Unit 13

The evaluation unit 13 evaluates an attribute related to at least any one of the luminance, hue, and saturation of the block (i,j) in accordance with at least one or each piece of pixel information in the block (i,j) of the color image composed of a plurality of pixel blocks. The evaluation unit 13 in the present embodiment evaluates a contrast level, which is an attribute related to luminance, of each block (i,j). In other words, the evaluation unit 13 performs step S13.

More specifically, the evaluation unit 13 obtains a luminance histogram for at least one or each piece of pixel information in the block (i,j) (see (a) to (c) of FIG. 4). The evaluation unit 13 also derives, from the luminance histogram, a minimum value (minimum gray level), a maximum value (maximum gray level), an average value (average gray level), and a gray level difference Δg between the minimum and maximum values of the pixel information in the block (i,j). Portions (a) to (c) of FIG. 4 show solid lines indicating a minimum value, a maximum value, and an average value and also show an arrow indicating a gray level difference Δg.

The evaluation unit 13 evaluates a contrast level of each pixel block in accordance with the average value and gray level difference Δg of that pixel block. For example, (1) if the block (i,j) has an average value in a range of 64 to 192 and a gray level difference Δg of less than 128, the evaluation unit 13 evaluates the contrast of the block (i,j) as being low. (2) If the block (i,j) has an average value in a range of 64 to 192 and a gray level difference Δg in a range of 128 to less than 192, the evaluation unit 13 evaluates the contrast of the block (i,j) as being high. (3) If the block (i,j) has an average value in a range of 64 to 192 and a gray level difference Δg of at least 192, the evaluation unit 13 evaluates the contrast of the block (i,j) as being excessively high.

Portion (a) of FIG. 4 shows an example luminance histogram for the block (i,j) evaluated as having a low contrast level. Portion (b) of FIG. 4 shows an example luminance histogram for the block (i,j) evaluated as having a high contrast level. Portion (c) of FIG. 4 shows an example luminance histogram for the block (i,j) evaluated as having an excessively high contrast level.

The criteria used by the evaluation unit 13 in evaluating the contrast level of the block (i,j) are not necessarily limited to these values and may be specified in another suitable manner. For example, the evaluation unit 13 may be configured to operate as follows. (1) If both the pixels having a gray level that is below a first prescribed gray level and the pixels having a gray level that is above or equal to a second prescribed gray level account for a proportion of all the pixels in the block (i,j) that is greater than or equal to a prescribed proportion, the evaluation unit 13 evaluates the contrast of the block (i,j) as being high. On the other hand, (2) if both the pixels having a gray level that is below the first prescribed gray level and the pixels having a gray level that is above or equal to the second prescribed gray level account for a proportion of all the pixels in the block (i,j) that is less than or equal to the prescribed proportion, the evaluation unit 13 evaluates the contrast of the block (i,j) as being low. Note that the second prescribed gray level is higher than the first prescribed gray level.

Process Determining Unit 14

The process determining unit 14 determines the specifics of a process to be performed on each piece of pixel information in the block (i,j) in accordance with a result of the evaluation performed by the evaluation unit 13. In other words, the process determining unit 14 performs step S14. The process determining unit 14 in the present embodiment determines, in accordance with a result of the evaluation of the contrast level of the block (i,j) performed by the evaluation unit 13, a contrast-changing amount for the block (i,j) (i.e., an amount by which the contrast of the block (i,j) will be changed).

The contrast-changing amount, or a specific of the process, in the present embodiment may be, for example, given as an integer from −30 to 30. In accordance with the result of the evaluation performed by the evaluation unit 13, the process determining unit 14 selects a contrast-changing amount for each pixel in the block (i,j) from the range of −30 to 30.

As am example, the process determining unit 14 selects a contrast-changing amount of +30 for a block (i,j) evaluated by the evaluation unit 13 as having low contrast, selects a contrast-changing amount of +10 for a block (i,j) evaluated by the evaluation unit 13 as having high contrast, and selects a contrast-changing amount of −20 for a block (i,j) evaluated by the evaluation unit 13 as having excessively high contrast.

### Image Processing Unit 15

The image processing unit 15, which is an image processing unit, performs a process on each piece of pixel information in the block (i,j) in accordance with the process specifics determined by the process determining unit 14. Specifically, the image processing unit 15 adjusts the output level of each piece of pixel information in the block (i,j) in accordance with the contrast-changing amount determined by the process determining unit 14. In other words, the image processing unit 15 performs step S15.

The present embodiment utilizes predetermined tone curves associated with respective contrast-changing amounts. The tone curves are contained, for example, in the memory unit 41. The image processing unit 15 adjusts the output level of each piece of pixel information in the block (i,j) in accordance with the contrast-changing amount, by selecting a tone curve associated with the contrast-changing amount determined by the process determining unit 14.

The tone curve shown in solid line in (a) of FIG. 5 is associated with a contrast-changing amount of +30. The tone curve shown in broken line in (a) of FIG. 5 is used when the contrast-changing amount is equal to 0, that is, when contrast is not to be changed.

The image processing unit 15 selects the tone curve shown in solid line in (a) of FIG. 5 and adjusts each piece of pixel information in the block (i,j), which results in an increase in the contrast level of the block (i,j).

Each tone curve associated with a contrast-changing amount may have a shape determined in a suitable manner by a design engineer in designing the image processing device 11. For example, the tone curve associated with a contrast-changing amount of +30 is not necessarily the tone curve shown in (a) of FIG. 5 and may alternatively be, as an example, the tone curve shown in (b) of FIG. 5. In other words, the amount by which to decrease the output level in regions of low input levels may differ from the amount by which to increase the output level in regions of high input levels.

### Attributes of Image Block

The image processing device 11 in accordance with the present embodiment evaluates contrast, which is an attribute related to the luminance of the block (i,j), in accordance with at least one or each piece of pixel information in the block (i,j). The image processing device 11 then determines specifics for a process to be performed on at least one or each piece of pixel information in the block (i,j) in accordance with a result of the evaluation and performs the process on the at least one or each piece of pixel information in the block (i,j) in accordance with the process specifics.

Alternatively, the image processing device 11 may be configured to evaluate either of the attributes, hue and saturation, of the block (i,j) in accordance with the at least one or each piece of pixel information in the block (i,j).

For example, the evaluation unit 13, the process determining unit 14, and the image processing unit 15 may be configured as in the following to evaluate the saturation of the block (i,j) in accordance with pixel information in the block (i,j). The evaluation unit 13 evaluates the saturation of the block (i,j) in accordance with pixel information in the block (i,j). The process determining unit 14 determines a saturation-changing amount for the block (i,j) in accordance with the saturation of the block (i,j) evaluated by the evaluation unit 13. The image processing unit 15 adjusts the output level of each piece of pixel information in the block (i,j) in such a manner that the output level corresponds to the saturation-changing amount determined by the process determining unit 14.

For example, the evaluation unit 13 evaluates saturation in each piece of the pixel information in accordance with the pixel information in the block (i,j) and gives results in integers from 0 to 100. The evaluation unit 13 calculates an average saturation of the block (i,j) by averaging saturation in each piece of the pixel information across the block (i,j). If the average saturation of the block (i,j) is at least 20 and less than 50, the evaluation unit 13 evaluates the saturation of the block (i,j) as being low.

The process determining unit 14 determines the saturation-changing amount for the block (i,j) in accordance with a result of the evaluation performed by the evaluation unit 13. For example, the process determining unit 14 selects a saturation-changing amount of +20 for a block (i,j) evaluated by the evaluation unit 13 as having low saturation.

The image processing unit 15 may perform the process, or more specifically, adjust the output level of each piece of pixel information in order to change the saturation of the block (i,j), by any proper conventional method. Examples of such a method of changing saturation include the following three methods. (1) The RGB signals are converted to YCbCr signals, which are then multiplied by a factor and converted back to RGB signals. (2) L*a*b* space is used. (3) RGB signals are simply multiplied by a factor as in equation (1):

$$\begin{matrix}[ Math . 1 ] & \\ ( \begin{matrix}{R}_{output} \\ {G}_{output} \\ {B}_{output}\end{matrix} ) = ( \begin{matrix}{K}_{1} & {K}_{2} & {K}_{2} \\ {K}_{2} & {K}_{1} & {K}_{2} \\ {K}_{2} & {K}_{2} & {K}_{1}\end{matrix} ) ( \begin{matrix}{R}_{input} \\ {G}_{input} \\ {B}_{input}\end{matrix} ) & ( 1 )\end{matrix}$$

where Rᵢₙₚᵤₜ, Gᵢₙₚᵤₜ, and Bᵢₙₚᵤₜ represent gray levels in pixel information before the saturation is changed; Rₒᵤₜₚᵤₜ, Gₒᵤₜₚᵤₜ, and Bₒᵤₜₚᵤₜ represent gray levels in pixel information after the saturation is changed; and the 3×3 matrix represents a multiplication factor.

Using one of these saturation-changing methods, the image processing unit 15 adjusts each piece of pixel information in the block (i,j) in such a manner that the saturation of the block (i,j) is changed by the saturation-changing amount determined by the process determining unit 14.

For example, the evaluation unit 13, the process determining unit 14, and the image processing unit 15 may be configured as in the following to evaluate the luminosity of the block (i,j) in accordance with at least one or each piece of pixel information in the block (i,j). The evaluation unit 13 evaluates the luminosity of the block (i,j) in accordance with at least one piece of pixel information in the block (i,j). The process determining unit 14 determines a luminosity-changing amount for the block (i,j) in accordance with the luminosity of the block (i,j) evaluated by the evaluation unit 13. The image processing unit 15 adjusts at least one or each piece of pixel information in the block (i,j) in such a manner that the at least one or each piece of pixel information corresponds to the luminosity-changing amount determined by the process determining unit 14. Luminosity is a re-definition using a different set of equations from the set used for luminance on the basis of gray levels of red, green, and blue. Therefore, luminosity is an attribute related to luminance.

For example, the evaluation unit 13, the process determining unit 14, and the image processing unit 15 may be configured as in the following to evaluate the hue of the block (i,j) in accordance with at least one or each piece of pixel information in the block (i,j). The evaluation unit 13 evaluates the hue of the block (i,j) in accordance with at least one piece of pixel information in the block (i,j). The process determining unit 14 determines a hue-changing amount for the block (i,j) in accordance with the hue of the block (i,j) evaluated by the evaluation unit 13. The image processing unit 15 adjusts at least one or each piece of pixel information in the block (i,j) in such a manner that the at least one or each piece of pixel information corresponds to the hue-changing amount determined by the process determining unit 14.

For example, the evaluation unit 13 evaluates, in accordance with each piece of pixel information in the block (i,j), whether or not the hue of the block (i,j) matches skin color. Specifically, the evaluation unit 13 evaluates whether or not each piece of pixel information in the block (i,j) indicates that the gray level for red is at least 220 and less than 250, the gray level for green is at least 170 and less than 220, and the gray level for blue is at least 130 and less than 220.

If the hue of the block (i,j) is evaluated as matching skin color, the process determining unit 14 determines, for example, to perform smoothing on the hue of the block (i,j). Alternatively, under the same conditions, the process determining unit 14 may determine not to change the hue of the block (i,j), or in other words, may determine to perform no process on the plural pieces of pixel information in the block (i,j).

As described so far, the evaluation unit 13 and the process determining unit 14 may be configured as in the following in the image processing device 11. The evaluation unit 13 evaluates, in accordance with at least one or each piece of pixel information in the block (i,j), whether or not the block (i,j) satisfies prescribed conditions. If the block (i,j) satisfies the prescribed conditions, the process determining unit 14 determines, as process specifics, to perform no process on the at least one or each piece of pixel information in the block (i,j).

The image processing unit 15 may perform the process, or more specifically, adjust the output level of each piece of pixel information in order to smooth out the hue of the block (i,j), by any proper conventional method similarly to the saturation-changing process. Examples of such a method include the following. (1) The color in each piece of pixel information represented by RGB signals is converted to L*a*b* space, (2) the chromaticity levels (a* and b*) of adjacent pixel information are smoothed out, and (3) the smoothed color of each piece of pixel information is converted from L*a*b* space back to RGB signals.

Using this hue-smoothing method, the image processing unit 15 adjusts each piece of pixel information in the block (i,j) in such a manner that the hue of the block (i,j) is smoothed out.

As another alternative, the image processing device 11 may evaluate a combination of at least two of the attributes, luminance (contrast), hue, and saturation, of the block (i,j).

For example, to evaluate a combination of the luminance and hue of the block (i,j), the evaluation unit 13 evaluates, in accordance with each piece of pixel information in the block (i,j), whether the block (i,j) is monochromatic or achromatic. In other words, the evaluation unit 13 evaluates whether or not each piece of pixel information in the block (i,j) indicates a fixed luminance level and a fixed gray level for red, green, and blue.

If the block (i,j) is evaluated as being monochromatic or achromatic alone, the process determining unit 14 determines not to perform a process on any pieces of pixel information in the block (i,j).

FIG. 6 shows an example of process specifics determined by evaluating a combination of attributes each related to at least any one of luminance, hue, and saturation. FIG. 6 is an enlarged plan view of image blocks, showing example process specifics determined by the process determining unit 14. The image processing device 11 is capable of performing an elaborate process on each block (i,j) in accordance with the characteristics of the block (i,j) as shown in FIG. 6. The specifics of the process performed by the image processing device 11 may include edge enhancement as noted in block (3,3).

### Process Adjustment Unit 16

FIG. 7 shows other example process specifics determined by the process determining unit 14. Referring to FIG. 7, the process determining unit 14 selects a saturation-changing amount of +20 for the block (i,j) and selects not to perform a process on the adjoining blocks (nearest block) of the block (i,j); namely, blocks (i−1,j−1), (i−1,j), (i−1,j+1), (i,j−1), (i,j+1), (i+1,j−1), (i+1,j), and (i+1,j+1). The block (i,j) is an equivalent of the first pixel block recited in the claims, whereas the blocks (i−1,j−1), (i−1,j), (i−1, j+1), (i,j−1), (i, j+1), (i+1, j−1), (i+1,j), and (i+1,j+1) are equivalents of the second pixel block recited in the claims.

Portion (a) of FIG. 8 shows a graph representing a saturation-changing amount determined for the blocks (i,j−1), (i,j), and (i,j+1) shown in FIG. 7. A process performed on each piece of pixel information representing the image 51 in accordance with the process specifics shown in FIG. 7 could result in such a large and clear difference in saturation at the boundary between the block (i,j) and the adjoining blocks thereof that the user can recognize it. The user may thus find unnatural the image represented by the image data constituted by the pixel information processed in accordance with the process specifics.

The process adjustment unit 16, which is the process adjustment unit recited in the claims, adjusts either or both of the process specifics (first process specific) to be applied to the block (i,j) and the process specifics (second process specific) to be applied to the adjoining blocks thereof. This configuration enables the process adjustment unit 16 to produce continuity between the effect of the first process specific and the effect of the second process specific (smoothly connect the first process specific and the second process specific). The process adjustment unit 16 hence reduces the possibility of the user recognizing the saturation level difference.

The first process specific and the second process specific may be smoothly connected by any mode. Some examples are illustrated in (b) to (e) of FIG. 8, which show graphs representing saturation parameter levels obtained when an edge process and a saturation-increasing process are performed on the block (i,j) and the adjoining blocks thereof shown in FIG. 7.

In the mode illustrated in (b) of FIG. 8, the saturation-changing amount for the adjoining blocks of the block (i,j) is decreased linearly to 0 within the boundary of the adjoining blocks whilst the saturation-changing amount for the block (i,j) is maintained at +20. Accordingly, the mode illustrated in (b) of FIG. 8 remedies the discontinuity of the saturation-changing amount that may occur at or near the boundary between the block (i,j) and the adjoining blocks thereof.

In the mode illustrated in (c) of FIG. 8, the saturation-changing amount for the adjoining blocks of the block (i,j) is decreased quadratically to 0 within the boundary of the adjoining blocks whilst the saturation-changing amount for the block (i,j) is maintained at +20. Accordingly, the mode illustrated in (c) of FIG. 8 remedies the discontinuity of the saturation-changing amount that may occur at or near the boundary between the block (i,j) and the adjoining blocks thereof.

In the mode illustrated in (d) of FIG. 8, the saturation-changing amount is quadratically decreased as in the mode illustrated in (c) of FIG. 8. The mode illustrated in (d) of FIG. 8 however differs from the mode illustrated in (c) of FIG. 8 in that the saturation-changing amount is decreased not only in the adjoining blocks, but starting in the proximity to the outer periphery of the block (i,j).

In the mode illustrated in (e) of FIG. 8, the saturation-changing amount is decreased linearly to 0 whilst the saturation-changing amount for the block (i,j) is maintained at +20 as in the mode illustrated in (b) of FIG. 8. The mode illustrated in (e) of FIG. 8 however differs from the mode illustrated in (b) of FIG. 8 in that the saturation-changing amount is gradually decreased not only in the nearest blocks (adjoining blocks), but starting in the second nearest blocks surrounding the nearest blocks.

This adjustment of process specifics for smoothly connecting the first process specific and the second process specific can remedy unnatural appearance that may occur in the image represented by the image data constituted by the processed pixel information.

The description has so far focused primarily on the row of blocks (i,j) in the image 51. The same description applies to the column and oblique (diagonal) array of blocks (i,j) in the image 51.

### Application to Monochromatic Images

The present embodiment has so far described a configuration of the image processing device 11 by taking as an example the image processing device 11 performing image processing on image data representing a color image. The image processing device 11 does not necessarily process image data representing a color image and may process image data representing a monochromatic image.

Image data representing a monochromatic image is given in the form of signals representing gray levels of a single color (e.g., white). The gray levels of a single color may be understood as luminance levels. Therefore, the image processing device 11 is capable of performing one of the above-described processes on image data representing a monochromatic image in accordance with the luminance levels of the blocks (i,j). In other words, the image processing device 11 is applicable to both image data representing a monochromatic image and image data representing a color image.

The inventors of the present application has found that the visual appearance of the image is not sufficiently improved by the dithering alone that is performed by the image processing device described in Patent Literature 1 on those blocks determined to constitute a grayscale image region. The image processing device described in Patent Literature 1 fails to improve the visual appearance of an image, in particular, when the image processing device is applied to a natural image (e.g., an image as it is captured by a camera).

On the other hand, the inventors of the present application has found that since the image processing device 11 is capable of performing elaborate contrast adjustment in accordance with the contrast of the block (i,j), the image processing device 11 can improve the visual appearance of an image better than the image processing device described in Patent Literature 1. The image processing device 11 is particularly suited for use with image data representing a natural image.

### APPLICATION EXAMPLES

The present embodiment has so far described the image processing device 11 in relation to the digital camera 1 which is an example of the image display device. The image processing device 11 is not necessarily provided in a digital camera and may be provided in any image display device that needs to automatically perform a process on pixel information constituting, for example, incoming image data. Examples of such an image display device include display devices such as printers, LCDs, and TV monitors and smartphones equipped with an image capturing unit. In addition, the above-described functions of the image processing device 11 may be performed in a specific working mode (e.g., “aesthetic mode” or “vivid mode”) of a printer.

If the control blocks of the image processing device 11 (i.e., the image dividing unit 12, the evaluation unit 13, the process determining unit 14, the image processing unit 15, and the process adjustment unit 16) are to be implemented by software, the software may be designed for a personal computer or a smartphone (“apps”). The present invention, in an aspect thereof, is suited for use to automatically develop the image data captured by an image capturing unit provided in a smartphone. Because the smartphone is not designed to store image data in raw image format, gray level saturation and loss often occur when the image data is saved for the first time. The use of the image processing device 11 can reduce this loss of gray level information.

### First Example

FIG. 9 shows a result of a process performed by the image processing device 11 in accordance with the present embodiment on image-representing image data generated by the image capturing unit 21. Portion (a) of FIG. 9 shows the image 51 represented by image data that is acquired by the image processing device 11. In other words, the image 51 is an image represented by unprocessed image data. Portion (b) of FIG. 9 shows an image 52 represented by image data processed by the image processing device 11. Portion (c) of FIG. 9 shows an image 152 represented by image data processed by an image processing device in accordance with a comparative example. The image processing device in accordance with a comparative example is configured to perform a uniform process on all the pixel information constituting plural sets of image-representing image data.

The image 51 is a photograph of a child in a flower garden. The image processing device 11 is configured to process an image so as to increase saturation levels in flowers, skies, and like regions determined to have vivid colors, in order to improve the visual appearance of the image 51.

The image processing device in accordance with a comparative example performs a saturation-increasing process uniformly on all the pixel information constituting the image data representing the image 51. The process results in changes of the color of the child's face (see (c) of FIG. 9). In other words, it is difficult to improve the visual appearance of the image 51 if the image processing device in accordance with the comparative example is used.

The image processing device 11 is capable of dividing image-representing image data into a plurality of blocks (i,j) before performing a process on each piece of pixel information in each block (i,j) with specifics that are in accordance with an attribute of that block (i,j). More specifically, the image processing device 11 enables elaborate selection of process specifics, such as contrast increases, saturation increases, and process inhibition, in accordance with an attribute of each block (i,j).

As a result, as shown in (b) of FIG. 9, the image processing device 11 is capable of generating image data representing the image 52 by increasing the saturation levels of the blocks (i,j) in a region determined to be a part of a flower while restricting the colors of the blocks (i,j) from changing in a region determined to be a part of a child's face. Hence, the image processing device 11 is capable of improving the visual appearance of the image.

### Second Embodiment

An image processing device 11 in accordance with a second embodiment of the present invention will be described in reference to FIG. 10. FIG. 10 is an enlarged plan view of the image 51, showing an arrangement of pixel blocks (i,j) the attributes of which are evaluated by the evaluation unit 13 provided in the image processing device 11 in accordance with the present embodiment.

The image processing device 11 in accordance with the present embodiment differs from the image processing device 11 in accordance with the first embodiment in that in the former, the evaluation unit 13 and the process determining unit 14 perform different processes than in the latter. The following description will describe the specifics of a process performed by the evaluation unit 13 and the process determining unit 14 in the present embodiment. The image dividing unit 12, the image processing unit 15, and the process adjustment unit 16 in the image processing device 11 in accordance with the present embodiment have the same configuration as those in the image processing device 11 in accordance with the first embodiment.

### Evaluation Unit 13

The evaluation unit 13 described in the first embodiment, as mentioned earlier, evaluates an attribute related to at least any one of the luminance, hue, and saturation of each block (i,j) in the color image composed of a plurality of pixel blocks in accordance with at least one or each piece of pixel information in that block (i,j). In the present embodiment, the evaluation unit 13 evaluates an attribute related to at least any one of the luminance, hue, and saturation of each block (i,j) in accordance with, in addition to at least one or each piece of pixel information in the block (i,j), at least one or each piece of pixel information in the blocks (i,j) surrounding the block (i,j).

As shown in FIG. 10, a block 511, or a block (i,j), is surrounded by eight nearest blocks 512 of pixels, which are in turn surrounded by 16 second nearest blocks 513 of pixels.

The evaluation unit 13 is configured to evaluate an attribute of the block (i,j) in accordance with all the pixel information in the block 511 and the nearest blocks 512. Alternatively, the evaluation unit 13 may be configured to evaluate an attribute of the block (i,j) in accordance with all the pixel information in the block 511, the nearest blocks 512, and the second nearest blocks 513. The following description will focus on an example where the evaluation unit 13 evaluates an attribute of the block (i,j) in accordance with all the pixel information in the block 511 and the nearest blocks 512. The focus is on an example where the evaluation unit 13 evaluates luminosity, which is one of the attributes of the block (i,j).

The evaluation unit 13 evaluates luminosity in each piece of pixel information in the block 511 in accordance with the pixel information and gives results in integers from 0 to 100. The evaluation unit 13 calculates an average luminosity of the block 511 by averaging luminosity in each piece of the pixel information across the block 511. The evaluation unit 13 also evaluates luminosity in each piece of pixel information in the nearest blocks 512 in accordance with the pixel information, gives results in integers from 0 to 100, and calculates an average luminosity of the nearest blocks 512.

The evaluation unit 13 also calculates a luminosity difference Δb between the average luminosity of the nearest blocks 512 and the average luminosity of the block 511. If the luminosity difference Δb is at least +10 and less than +30, the evaluation unit 13 evaluates the block 511 as having higher luminosity than the nearest blocks.

### Process Determining Unit 14

The process determining unit 14 determines a luminosity-changing amount for the block 511 in accordance with a result of the evaluation performed by the evaluation unit 13. As an example, the process determining unit 14 selects a luminosity-changing amount of +30 for the pixel information in the block 511 that is evaluated by the evaluation unit 13 as having higher luminosity than the nearest blocks. The process determining unit 14 also determines not to perform a process on the pixel information in the block 511 that is evaluated by the evaluation unit 13 as not having higher luminosity than the nearest blocks.

As described in the foregoing, the image processing device 11 is capable of enhancing the brightness of bright regions in the image 51 by performing a process of further increasing the luminosity of the block 511 that has higher luminosity than the luminosity of the nearest blocks 512. Hence, the image processing device 11 is capable of improving the visual appearance of the image 51.

### VARIATION EXAMPLES

As a variation example, the evaluation unit 13 and the process determining unit 14 may be configured as in the following to evaluate luminosity, which is one of the attributes of the block (i,j).

The evaluation unit 13, in accordance with each piece of pixel information in the block 511, evaluates hue in each piece of pixel information and gives results in integers from −180 to 180 and also evaluates saturation in each piece of pixel information and gives results in integers from 0 to 100. The evaluation unit 13 calculates an average hue and an average saturation of the block 511 by averaging hue and saturation in each piece of pixel information in the block 511.

The evaluation unit 13, in accordance with plural pieces of pixel information in the nearest blocks 512, further evaluates hue in each piece of pixel information and gives results in integers from −180 to 180 and also evaluates saturation in each piece of pixel information and gives results in integers from 0 to 100. The evaluation unit 13 calculates an average hue and an average saturation of the nearest blocks 512 by averaging hue and saturation in each piece of pixel information in the nearest blocks 512.

The evaluation unit 13 also calculates a hue difference Δh between the average hue of the nearest blocks 512 and the average hue of the block 511. If the hue difference Δh is from −10 to +10, and both the average saturation of the block 511 and the average saturation of the nearest blocks 512 are at least 20 and less than 50, the evaluation unit 13 evaluates the block 511 and the nearest blocks 512 as having the same color and the block 511 as having low saturation.

The process determining unit 14 determines a saturation-changing amount for the block 511 in accordance with a result of the evaluation performed by the evaluation unit 13. As an example, the process determining unit 14 selects a saturation-changing amount of +20 for each piece of pixel information in the block 511 and the nearest blocks 512 if the evaluation unit 13 has evaluated the block 511 and the nearest blocks 512 as having the same color and having low saturation.

Meanwhile, if the evaluation unit 13 has evaluated the block 511 and the nearest blocks 512 as having different colors, the process determining unit 14 selects a saturation-changing amount for each piece of pixel information in the block 511 in accordance with a result of evaluation related to saturation.

### Third Embodiment

An image processing device 111 in accordance with a third embodiment of the present invention will be described in reference to FIGS. 11 to 14. FIG. 11 is a block diagram of the image processing device 111 and a digital camera 101 including the image processing device 111. FIG. 12 is a flow chart representing a flow of a process carried out in the image processing device 111. FIG. 13 is a plan view of a screen displaying pixel block groups each associated with a prescribed type of subject by a detection unit 117 provided in the image processing device 111. Portion (a) of FIG. 14 is an image 151 represented by image data that is acquired by the image processing device 111. Portion (b) of FIG. 14 is an image 152 represented by image data constituted by the pixel information that has been subjected to image processing in the image processing device 111.

Referring to FIG. 11, the image processing device 111 includes an image dividing unit 112, an evaluation unit 113, a process determining unit 114, an image processing unit 115, a process adjustment unit 116, and the detection unit 117. The image processing device 111 differs from the image processing device 11 in accordance with the first embodiment in that the image processing device 111 additionally includes the detection unit 117. The image dividing unit 112, the evaluation unit 113, the process determining unit 114, the image processing unit 115, and the process adjustment unit 116 have the same configuration as the image dividing unit 12, the evaluation unit 13, the process determining unit 14, the image processing unit 15, and the process adjustment unit 16 in the image processing device 11 respectively.

As shown in FIG. 12, the image processing method implemented by the image processing device 111 includes step S111, step S112, step S113, step S114, step S115, step S116, and step S117. In step S111, image data is obtained. The image data is then divided into a plurality of pixel blocks in step S112. The contrast of each pixel block is evaluated in step S113. Step S114 detects a pixel block group associated with a prescribed type. In step S115, an attribute of the pixel blocks in the pixel block group is evaluated. Step S116 then determines the specifics of a process to be performed on each piece of pixel information. The process is performed on each piece of pixel information in step S117. Steps S111 to S113 and steps S116 to S117 correspond respectively to steps S11 to S15 shown in FIG. 2.

The following will describe how the image processing device 111 differs from the image processing device 11, focusing on the detection unit 117 and steps S114 to S115.

### Detection Unit 117

The detection unit 117 detects a pixel block group of adjacent blocks (i,j) that is associated with a prescribed type of subject. In other words, the detection unit 117 performs step S114.

The detection unit 117 utilizes, for example, existing face detection algorithms, object detection algorithms, and deep learning in order to detect a pixel block group of adjacent blocks (i,j) that is associated with a prescribed type of subject.

Referring to FIG. 13, the shadow of the photographer overlaps a flower region in the image 151. The detection unit 117, upon acquiring image data representing the image 151, detects a face region 1511, a flower region 1512, and a shaded region 1513 in the image 151 as pixel block groups.

The face region 1511 is a pixel block group associated with the face of a subject (child). The flower region 1512 is a pixel block group associated with another subject (flowers). The shaded region 1513 is a pixel block group associated with a further subject (the shadow of the photographer overlapping the flowers). This example demonstrates that the prescribed type of subject in the present embodiment is not necessarily a real object such as a person or flowers and may be a visual effect of light intensity created under light, such as a shadow.

The evaluation unit 113 evaluates an attribute related to at least any one of the luminance, hue, and saturation of each block (i,j) in the face region 1511, the flower region 1512, and the shaded region 1513 in accordance with each piece of pixel information in that block (i,j). Note that to evaluate an attribute of the blocks (i,j) in the face region 1511, the flower region 1512, and the shaded region 1513, either the same attribute or different attributes may be used in (1) the evaluation of the blocks (i,j) in the face region 1511, (2) the evaluation of the blocks (i,j) in the flower region 1512, and (3) the evaluation of the blocks (i,j) in the shaded region 1513. These attributes may be determined, where necessary, by recognizing the characteristics of a prescribed type of subject in advance.

The evaluation unit 113 performs step S115 as well as step S113 as described here.

The process determining unit 114 determines the specifics of a process to be performed on each piece of pixel information in the blocks (i,j) in a pixel block group in accordance with either or both of the attribute (contrast) of the blocks (i,j) in the pixel block groups evaluated in step S113 and the prescribed type associated with the pixel block groups evaluated in step S115. In other words, the process determining unit 114 performs step S116.

For example, the process determining unit 114 is configured to (1) select, as process specifics, to perform no process if the prescribed subject is a face, (2) select, as process specifics, a saturation-changing amount of +20 if the prescribed subject is flowers, and (3) select, as process specifics, a luminosity-changing amount of +30 if the prescribed subject is a shadow.

The evaluation performed in accordance with an attribute of the pixel block described in the first embodiment is effective in extracting characteristics that are common across a small area of an image. Meanwhile, the evaluation performed in accordance with an attribute of the pixel block group associated with a prescribed type of subject described in the present embodiment is effective in extracting characteristics that are common across a large area of an image. The visual appearance of the image can be more properly improved by selecting process specifics in view of characteristics that are common across a small area of an image and characteristics that are common across a large area of the image.

The detection unit 117 may be configured to associate the shaded region 1513 only with the shadow of a photographer or may be configured to associate the shaded region 1513 with both the shadow of a photographer and flowers. If the detection unit 117 is configured to associate the shaded region 1513 only with the shadow of a photographer, the process determining unit 114 determines the specifics of a process to be performed on each piece of pixel information in the blocks (i,j) in a pixel block group on the basis of a prescribed type that is the shadow. If the detection unit 117 is configured to associate the shaded region 1513 with both the shadow of a photographer and flowers, the process determining unit 114 determines the specifics of a process to be performed on each piece of pixel information in the blocks (i,j) in a pixel block group on the basis of prescribed types that are the shadow and flowers.

Apart from the face region 1511, the flower region 1512, and the shaded region 1513, none of the regions in the image 151 is associated with a prescribed type of subject. The process determining unit 114 may be configured to select predetermined process specifics for those regions associated with the prescribed types of subjects that are the face, flowers, and shadow and select process specifics in accordance with an attribute of the block (i,j) for those regions associated with no prescribed type of subject.

The process determining unit 114 may be configured to refer to the metadata contained in the image data representing the image in selecting process specifics. For example, if the metadata of the image 151 contains a key word, “flowers,” it can be safely presumed that the photographer has paid attention to flowers when taking the image 151. In such cases, the process determining unit 114 may be configured to designate flowers as the only prescribed type of subject and disregard the face. This example demonstrates that by referring to key words in the metadata, the process determining unit 114 can reflect the intention of the photographer in determining the specifics of image processing.

### Second Example

FIG. 14 shows a result of a process performed by the image processing device 111 on the image data representing an image captured by the image capturing unit 21. Portion (a) of FIG. 14 shows the image 151 represented by image data that is acquired by the image processing device 111. In other words, the image 151 is an image represented by unprocessed image data. Portion (b) of FIG. 14 shows the image 152 represented by image data that is processed by the image processing device 111.

The image 151 is a photograph of a child in a flower garden similarly to the image 51 shown in FIG. 9. The shadow of the photographer overlaps flowers in the image 151 as described earlier. The image processing device 111 is configured to increase luminosity in a region determined to be in a shadow, as well as to increase saturation in a region determined to have vivid colors, in order to improve the visual appearance of the image 151.

This configuration, as shown in (b) of FIG. 14, enables the image processing device 111 to restrain the effects of the shadow of the photographer overlapping flowers. Hence, the image processing device 111 is capable of improving the visual appearance of the image 151.

### Software Implementation

The control blocks of the image processing device 11 (the image dividing unit 12, the evaluation unit 13, the process determining unit 14, the image processing unit 15, and the process adjustment unit 16) may be implemented by logic circuits (hardware) fabricated, for example, in the form of an integrated circuit (IC chip) and may be implemented by software executed by a CPU (central processing unit).

In the latter form of implementation, the image processing device 11 includes among others a CPU that executes instructions from programs or software by which various functions are implemented, a ROM (read-only memory) or like storage device (referred to as a “storage medium”) containing the programs and various data in a computer-readable (or CPU-readable) format, and a RAM (random access memory) into which the programs are loaded. The computer (or CPU) then retrieves and executes the programs contained in the storage medium, thereby achieving the object of the present invention. The storage medium may be a “non-transient, tangible medium” such as a tape, a disc, a card, a semiconductor memory, or programmable logic circuitry. The programs may be fed to the computer via any transmission medium (e.g., over a communications network or by broadcasting waves) that can transmit the programs. The present invention, in an aspect thereof, encompasses data signals on a carrier wave that are generated during electronic transmission of the programs.

### General Description

The present invention, in aspect 1 thereof, is directed to an image processing device (11, 111) including: an evaluation unit (13, 113) configured to evaluate an attribute related to at least any one of luminance, hue, and saturation of each one of pixel blocks (block (i,j)) in accordance with at least one piece of pixel information in that pixel block (block (i,j)), the pixel blocks being specified by dividing an image (51, 151) into a plurality of regions; a process determining unit (14, 114) configured to determine, in accordance with a result of the evaluation performed by the evaluation unit, a process specific to be applied to the at least one piece of pixel information; and an image processing unit (15, 115) configured to process the at least one piece of pixel information in accordance with the process specific.

According to this configuration, the image processing device (11, 111) is capable of performing a process on at least one or each piece of pixel information in each pixel block (block (i,j)) in accordance with a process specific that is suited for an attribute of the pixel block (block (i,j)). Therefore, the image processing device (11, 111) can prevent, for example, color loss and blown highlights that may occur in a processed image (51, 151). The image processing device (11, 111) is capable of performing image processing on image data representing a color image, as well as on image data representing a monochromatic image, in such a manner as to make the image look better as detailed here.

In aspect 2 of the present invention, the image processing device (11, 111) of aspect 1 may be configured such that: the evaluation unit (13, 113) evaluates a contrast level of each one of the pixel blocks (block (i,j)) in accordance with the at least one piece of pixel information; the process determining unit (14, 114) determines a contrast-changing amount for that pixel block (block (i,j)) in accordance with the contrast level evaluated by the evaluation unit (13, 113); and the image processing unit (15, 115) adjusts the at least one piece of pixel information in such a manner that the at least one piece of pixel information corresponds to the contrast-changing amount determined by the process determining unit (14, 114).

According to this configuration, the image processing device (11, 111) determines a process specific in accordance with contrast, which is a luminance-related one of attributes of the pixel block (block (i,j)). Therefore, the image processing device (11, 111) can reliably prevent, for example, color loss and blown highlights that may occur in a processed image.

In aspect 3 of the present invention, the image processing device (11) of aspect 2 may be configured such that: the evaluation unit (13) obtains a luminance histogram for the at least one piece of pixel information and evaluates a contrast level of each one of the pixel blocks (block (i,j)) in accordance with (1) an average gray level in the luminance histogram and (2) a gray level difference between a minimum gray level and a maximum gray level in the luminance histogram; and the image processing unit (15) selects a tone curve associated with the contrast-changing amount determined by the process determining unit (14).

According to this configuration, the image processing device (11) is capable of evaluating the contrast of each pixel block (block (i,j)) in a suitable manner and adjusting contrast in the plural pieces of pixel information in each pixel block (block (i,j)) in a suitable manner.

In aspect 4 of the present invention, the image processing device (11) of any one of aspects 1 to 3, may be configured such that: the evaluation unit (13) evaluates saturation of each one of the pixel blocks (block (i,j)) in accordance with the at least one piece of pixel information; the process determining unit (14) determines a saturation-changing amount for that pixel block (block (i,j)) in accordance with the saturation evaluated by the evaluation unit (13); and the image processing unit (15) adjusts the at least one piece of pixel information in such a manner that the at least one piece of pixel information corresponds to the saturation-changing amount determined by the process determining unit (14).

In aspect 5 of the present invention, the image processing device (11) of any one of aspects 1 to 4, may be configured such that: the evaluation unit (13) evaluates luminosity of each one of the pixel blocks (block (i,j)) in accordance with the at least one piece of pixel information; the process determining unit (14) determines a luminosity-changing amount for that pixel block (block (i,j)) in accordance with the luminosity evaluated by the evaluation unit (13); and the image processing unit (15) adjusts the at least one piece of pixel information in such a manner that the at least one piece of pixel information corresponds to the luminosity-changing amount determined by the process determining unit (14).

In aspect 6 of the present invention, the image processing device (11) of any one of aspects 1 to 5 may be configured such that: the evaluation unit (13) evaluates hue of each one of the pixel blocks (block (i,j)) in accordance with the at least one piece of pixel information; the process determining unit (14) determines a hue-changing amount for that pixel block (block (i,j)) in accordance with the hue evaluated by the evaluation unit; and the image processing unit (15) adjusts the at least one piece of pixel information in such a manner that the at least one piece of pixel information corresponds to the hue-changing amount determined by the process determining unit (14).

As described in the foregoing, the image processing device (11) in accordance with an aspect of the present invention may be configured to perform image processing in accordance with any one of the saturation, luminosity, and hue of each one of the pixel blocks (block (i,j)) instead of performing image processing in accordance with the contrast level of each one of the pixel blocks (block (i,j)). Luminosity of each pixel block (block (i,j)) is luminance of that block (block (i,j)) expressed using a different definition.

In aspect 7 of the present invention, the image processing device (111) of any one of aspects 1 to 6 may further include a detection unit (117) configured to detect a pixel block group of adjacent pixel blocks (block (i,j)) that is associated with a prescribed type of subject, wherein: the evaluation unit (113) evaluates the attribute of each one of the pixel blocks (block (i,j)) in the pixel block group in accordance with the at least one piece of pixel information in that pixel block; and the process determining unit (114) determines a process specific to be applied to the at least one piece of pixel information in the pixel block (block (i,j)) in the pixel block group in accordance with either or both of the attribute and the prescribed type.

The evaluation performed in accordance with an attribute of each pixel block (block (i,j)) is effective in extracting characteristics that are common across a small area of an image (151). Meanwhile, the evaluation performed in accordance with an attribute of the pixel block group associated with a prescribed type of subject is effective in extracting characteristics that are common across a large area of an image (151). This configuration enables selection of a process specific in view of characteristics that are common across a small area of an image (151) and characteristics that are common across a large area of the image (151), thereby more properly improving the visual appearance of the image (151).

In aspect 8 of the present invention, the image processing device (11, 111) of any one of aspects 1 to 7 may further include an image dividing unit (12, 112) configured to externally acquire image data and to divide an image represented by the image data into the pixel blocks, wherein the pixel blocks (block (i,j)) each have a size of 50 to 300 pixels by 50 to 300 pixels.

If the pixel block (block (i,j)) includes very few pixels, it may become difficult to determine what characteristics the pixel block (block (i,j)) has. On the other hand, if the pixel block (block (i,j)) includes too many pixels, the pixel block (block (i,j)) will more likely have a variety of characteristics. In either case, optimal specifics may not be selected for the process. If the pixel count of the pixel blocks (block (i,j)) is not specified properly, optimal specifics may not be selected for the process as detailed here. The configuration described here enables selection of a suitable process specific in such a manner as to make the image look better.

In aspect 9 of the present invention, the image processing device (11, 111) of any one of aspects 1 to 8 may further include a process adjustment unit (16, 116) configured to adjust the process specific determined by the process determining unit (14, 114), wherein the process adjustment unit (16, 116) adjusts either or both of (1) a first process specific to be applied to a first pixel block (block (i,j)) that is one of pixel blocks and (2) a second process specific to be applied to a second pixel block (blocks (i−1,j−1), (i−1,j), (i−1,j+1), (i,j−1), (i,j+1), (i+1,j−1), (i+1,j), and (i+1,j+1)) that is adjacent to the first pixel block (block (i,j)), in order to produce continuity between an effect of the first process specific and an effect of the second process specific.

According to this configuration, the image processing device (11, 111) adjusts process specifics in such a manner to smoothly connect the first process specific and the second process specific. The image processing device (11, 111) can hence remedy unnatural appearance that may occur in the image (51, 151) represented by processed pixel information.

In aspect 10 of the present invention, the image processing device (11, 111) of any one of aspects 1 to 9 may be configured such that the evaluation unit (13, 113) evaluates the attribute of each one of the pixel blocks (block (i,j)) in accordance with the at least one piece of pixel information in that pixel block (block (i,j)) and in accordance with the at least one piece of pixel information in pixel blocks (blocks (i−1,j−1), (i−1,j), (i−1,j+1), (i,j−1), (i,j+1), (i+1,j−1), (i+1,j), and (i+1,j+1)) surrounding at least the pixel block (block (i,j)).

The evaluation unit (13, 113) may be configured in this manner to consider, in addition to each pixel block (the block (i,j)) and the surrounding blocks (blocks (i−1,j−1), (i−1,j), (i−1,j+1), (i,j−1), (i,j+1), (i+1,j−1), (i+1,j), and (i+1,j+1)) of that pixel block (block (i,j)) in evaluating an attribute of each pixel block (block (i,j)).

In aspect 11 of the present invention, the image processing device (11, 111) of any one of aspects 1 to 10 may be configured such that: the evaluation unit (13, 113) evaluates, in accordance with the at least one piece of pixel information, whether or not each one of the pixel blocks (block (i,j)) satisfies a prescribed condition; and if that pixel block (block (i,j)) satisfies the prescribed condition, the process determining unit (14, 114) determines, as the process specific, not to process the at least one piece of pixel information.

According to this configuration, the image processing device (11, 111) is capable of properly evaluating pixel blocks that should not be subjected to processing.

The present invention, in aspect 12 thereof, is directed to a digital camera (1) including: the image processing device (11, 111) of any one of aspects 1 to 11; and an image capturing unit (21) configured to generate image data and to supply the image data to the image processing device.

The digital camera (1) achieves similar advantages as the image processing device (11, 111) of any one of the aspects detailed above.

The image processing device (11, 111) of any one of the aspects of the present invention may be implemented on a computer, in which case the present invention encompasses an image processing program causing a computer to operate as various units of the image processing device in order to implement the image processing device on the computer and also encompasses a computer-readable storage medium containing the image processing program.

The present invention is not limited to the description of the embodiments above and may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

### CROSS-REFERENCE TO RELATED APPLICATIONS

The present application claims the benefit of priority to Japanese Patent Application, Tokugan, No. 2016-234515, filed on Dec. 1, 2016, the entire contents of which are incorporated herein by reference.

### REFERENCE SIGNS LIST

1, 101 Digital Camera
11, 111 Image Processing Device
12, 112 Image Dividing Unit
13, 113 Evaluation Unit
14, 114 Process Determining Unit
15, 115 Image Processing Unit
16, 116 Process Adjustment Unit
117 Detection Unit
21 Image Capturing Unit
31 Display Unit
41 Memory Unit

1. An image processing device comprising:
an evaluation unit configured to evaluate an attribute related to at least any one of luminance, hue, and saturation of each one of pixel blocks in accordance with at least one piece of pixel information in that pixel block, the pixel blocks being specified by dividing an image into a plurality of regions;
a process determining unit configured to determine, in accordance with a result of the evaluation performed by the evaluation unit, a process specific to be applied to the at least one piece of pixel information; and
an image processing unit configured to process the at least one piece of pixel information in accordance with the process specific.

2. The image processing device according to claim 1, wherein:
the evaluation unit evaluates a contrast level of each one of the pixel blocks in accordance with the at least one piece of pixel information;
the process determining unit determines a contrast-changing amount for that pixel block in accordance with the contrast level evaluated by the evaluation unit; and
the image processing unit adjusts the at least one piece of pixel information in such a manner that the at least one piece of pixel information corresponds to the contrast-changing amount determined by the process determining unit.

3. The image processing device according to claim 2, wherein:
the evaluation unit obtains a luminance histogram for the at least one piece of pixel information and evaluates a contrast level of each one of the pixel blocks in accordance with (1) an average gray level in the luminance histogram and (2) a gray level difference between a minimum gray level and a maximum gray level in the luminance histogram; and
the image processing unit selects a tone curve associated with the contrast-changing amount determined by the process determining unit.

4. The image processing device according to claim 1, wherein:
the evaluation unit evaluates saturation of each one of the pixel blocks in accordance with the at least one piece of pixel information;
the process determining unit determines a saturation-changing amount for that pixel block in accordance with the saturation evaluated by the evaluation unit; and
the image processing unit adjusts the at least one piece of pixel information in such a manner that the at least one piece of pixel information corresponds to the saturation-changing amount determined by the process determining unit.

5. The image processing device according to claim 1, wherein:
the evaluation unit evaluates luminosity of each one of the pixel blocks in accordance with the at least one piece of pixel information;
the process determining unit determines a luminosity-changing amount for that pixel block in accordance with the luminosity evaluated by the evaluation unit; and
the image processing unit adjusts the at least one piece of pixel information in such a manner that the at least one piece of pixel information corresponds to the luminosity-changing amount determined by the process determining unit.

6. The image processing device according to claim 1, wherein:
the evaluation unit evaluates hue of each one of the pixel blocks in accordance with the at least one piece of pixel information;
the process determining unit determines a hue-changing amount for that pixel block in accordance with the hue evaluated by the evaluation unit; and
the image processing unit adjusts the at least one piece of pixel information in such a manner that the at least one piece of pixel information corresponds to the hue-changing amount determined by the process determining unit.

7. The image processing device according to claim 1, further comprising a detection unit configured to detect a pixel block group of adjacent pixel blocks that is associated with a prescribed type of subject, wherein:
the evaluation unit evaluates the attribute of each one of the pixel blocks in the pixel block group in accordance with the at least one piece of pixel information in that pixel block; and
the process determining unit determines a process specific to be applied to the at least one piece of pixel information in the pixel block in the pixel block group in accordance with either or both of the attribute and the prescribed type.

8. The image processing device according to claim 1, further comprising an image dividing unit configured to externally acquire image data and to divide an image represented by the image data into the pixel blocks, wherein the pixel blocks each have a size of 50 to 300 pixels by 50 to 300 pixels.

9. The image processing device according to claim 1, further comprising a process adjustment unit configured to adjust the process specific determined by the process determining unit, wherein the process adjustment unit adjusts either or both of (1) a first process specific to be applied to a first pixel block that is one of the pixel blocks and (2) a second process specific to be applied to a second pixel block that is adjacent to the first pixel block, in order to produce continuity between an effect of the first process specific and an effect of the second process specific.

10. The image processing device according to claim 1, wherein the evaluation unit evaluates the attribute of each one of the pixel blocks in accordance with the at least one piece of pixel information in that pixel block and in accordance with at least one piece of pixel information in adjacent pixel blocks that surround the pixel block.

11. The image processing device according to claim 1, wherein:
the evaluation unit evaluates, in accordance with the at least one piece of pixel information, whether or not each one of the pixel blocks satisfies a prescribed condition; and
if that pixel block satisfies the prescribed condition, the process determining unit determines, as the process specific, not to process the at least one piece of pixel information.

12. A digital camera comprising:
an image processing device that comprises:
an evaluation unit configured to evaluate an attribute related to at least any one of luminance, hue, and saturation of each one of pixel blocks in accordance with at least one piece of pixel information in that pixel block, the pixel blocks being specified by dividing an image into a plurality of regions;
a process determining unit configured to determine, in accordance with a result of the evaluation performed by the evaluation unit, a process specific to be applied to the at least one piece of pixel information; and
an image processing unit configured to process the at least one piece of pixel information in accordance with the process specific; and
an image capturing unit configured to generate image data and to supply the image data to the image processing device.

13. A non-transitory computer-readable storage medium containing an image processing program causing a computer to operate as the image processing device according to claim 1, the image processing program causing the computer to operate as the evaluation unit, the process determining unit, and the image processing unit.

14. (canceled)

15. The image processing device according to claim 7, wherein the process determining unit refers to metadata contained in the image and designates only the pixel block group associated with the subject that matches content of the metadata as a target to be processed.
